(19) United States
(12) Patent Application Publication
(10) Pub. No.: US 2005/0097806 A1
(43) Pub. Date: May 12, 2005

(54) Cast - away bobber

(76) Inventors: James F. Schumacher, Mishawaka, IN (US); Kathleen S. Schumacher, Mishawaka, IN (US)

Correspondence Address: James. F. and Kathleen S. Schumacher, 309 W. Marion Street, Mishawaka, IN, 46545, US

(21) Appl. No.: 10/703,609

(22) Filed: Nov. 7, 2003

(51) Int. Cl. A01K 93/00

(52) U.S. Cl. 43/44.9

(57) ABSTRACT

The “Cast-Away Bobber” has an operation similar to other slip bobbers but it's make-up and performance are uniquely different. It has a hollow vertical tube through the center with a tubular pierced glass bead through which the fishing line is feed which won't wear out over extended usage. The two piece bonded float assembly has a make up of a closed cell light weight plastic foam for the upper section and a heavier foam rubber base for the bottom section, both sections are bonded together and then coated with several applications of different plastic dip paint for greater visibility and giving the bobber years of performance even if it's accidentally stepped on. The heavier foam rubber base gives the bobber a natural weight for a longer and more accurate cast even in windy conditions. The heavier base also gives the “Cast-Away Bobber” a somewhat angular position when floating in the water without adding additional weight or a sinker, however it is recommended to add a 0.4 oz (ounce) fishing weight to bring it to the total vertical position in the water and lighter weights for the smaller diameter bobbers The diameter of the “Cast-Away Bobber” varies from ¾″ (inch) diameter to 1¼″ (inch) diameter (as shown and submitted) in increments of ⅛″ and up to 2″ (inch) diameter bobber which is strictly used for musky and northern fishing (in fresh water lakes) and is able to hold a live minnow at a fixed depth without being pulled under as with the smaller diameter bobbers The 2″ diameter bobbers needs no sinker to make it stand upright in the water.

### CROSS REFERENCES TO RELATED APPLICATIONS

U>S> Patent Documents
Slip Bobbers

| | | | |
|---|---|---|---|
| 3381407 | May, 1968 | McDougall | 43/44 |
| 3443336 | May, 1969 | Reese | 43/44 |
| 3786595 | January, 1974 | Croce | 43/44 |
| 4757635 | July, 1988 | Cole | 43/44 |
| 5327672 | July, 1994 | Johnson | 43/44 |
| 5404669 | April, 1995 | Johnson | 43/44.91 |

Slip Bobber of Ice Fishing

| | | | |
|---|---|---|---|
| 1122359 | December, 1914 | Bissett | 43/44 |
| 1468720 | September, 1923 | Low | 43/44 |
| 2379676 | July, 1945 | Blackstone | 43/44 |
| 2503793 | April, 1950 | Breemes | 43/44 |
| 2581259 | January, 1952 | Keen | 43/44 |
| 4251941 | Febraury, 1981 | Howard | 43/44 |

Castable Fishing Bobber

| | | | |
|---|---|---|---|
| 3144729 | August, 1964 | Jonassen | 43/44 |
| 3425151 | Febraury, 1969 | Salfer | 43/44 |
| 4406081 | September, 1983 | Garner | 43/44 |
| 4574515 | May, 1986 | Garner | 43/44 |
| 4825580 | March, 1989 | Gray | 43/44 |

Two Piece Slip Bobbers

| | | | |
|---|---|---|---|
| 668254 | Febraury, 1901 | Dickinson | 43/44 |
| 729687 | June, 1903 | Smith | 43/44 |
| 1418944 | June, 1922 | Lower | 43/44 |
| 2162659 | June, 1939 | Wilson | 43/44 |
| 2302549 | November, 1942 | Hodges | 43/44 |

Adjustable Depth Fishing Bobber System

| | | | |
|---|---|---|---|
| 2834142 | May, 1958 | Saye | 43/44 |
| 2847792 | August, 1958 | Kuhlmann | 43/44 |
| 2902792 | September, 1959 | Friday | 43/44 |
| 3392475 | July, 1968 | Vakousky | 43/44 |
| 5117576 | June, 1992 | Lasiter | 43/44 |

Depth Changing Fishing Float

| | | | |
|---|---|---|---|
| 2153869 | April, 1939 | Jones | 43/49 |
| 2269615 | January, 1942 | Walker | 43/49 |
| 2597737 | May, 1952 | Kay et al. | 43/44 |
| 2609634 | September, 1952 | Simpson | 43/44 |
| 2777238 | January, 1957 | Taylor et al. | 43/44 |
| 2785499 | March, 1957 | Simpson | 43/44 |
| 2861382 | November, 1958 | Rosenberg | 43/44 |
| 2888771 | June, 1959 | Stephens et al | 43/44 |
| 3106797 | October, 1963 | Hancock | 43/44 |

Casting Bobber with Predetermined Depth Setting

| | | | |
|---|---|---|---|
| 771263 | October, 1904 | McCord | 43/44 |
| 1504884 | August, 1924 | Garst | 43/44 |
| 1986441 | January, 1935 | Koepke | 43/44 |
| 2326510 | August, 1943 | Worden | 43/49 |
| 2729015 | January, 1956 | Finnegan | 43/44 |
| 2778147 | January, 1957 | Peck | 43/44 |

### CONCEPTION—BACKGROUND OF THE INVENTION

In our many years of fishing with cork bobbers first than Styrofoam bobbers my wife and I were disappointed with how often bobbers would fall apart and the limited range we could cast in windy conditions. Later while swimming in our pool and playing catch with a foam rubber ball I realized it floated very well and that it was heavier than cork or styrofoam materials. I also work in the construction field and have worked with other materials such as backer rod (a light weight closed cell plastic material) used n control and expansion joints. I have also used adhesives such as PL-400 and liquid nails in construction and a quick drying plastic dip paint for coating tool handles and other products. During the years of experimenting with different materials and shapes my wife and I came up with this bobber design and call it the “Cast-Away Bobber” since it can be cast further than a conventional slip bobber.

### SUMMARY OF THE INVENTION

Many or the problems associated with most fishing bobbers and floats now on the market today is durability, the ability to cast longer distances and accuracy of casting during windy conditions. Most bobbers and floats only last for a short period of time basically due to the materials used and how the materials act due to one another during climate changes or while being stored away in the tackle box or in storage compartments in boats. While it's not the intention of users to abuse these bobbers accidents do happen, some get stepped on or smashed during storage, therefore rendering them useless.

Because of the weight or lack thereof unless a heavier weight is applied to the line which in most cases causes the bobber to sink below the surface of the water also making it useless. Most bobbers or floats are comprised of such light weight materials that they limit the distance on how far a person can cast it. Also because of the light weight materials used in bobbers and floats, the accuracy during casting can be affected during windy conditions.

Therefore the “Cast-Away Bobber” was developed so an individual can cast further from lake shores or river banks. While in the boat, areas that were hard to reach because of obstructions or structure can be reached without moving closer or as often. And because of the weight this bobber it's not as affected by wind as other bobbers are.

It is the intention of this invention to solve and eliminate these problems and provide an item revolutionary in it's design and composition. The “Cast Away Bobber” has been known to cast further, last longer and is more accurate in casting than other slip bobbers.

### BRIEF DESCRIPTION OF THE FIGURES OF THE DRAWING

FIG. 1 Is a Plan View (looking down) on the bobber.

FIG. 2 Is a Cross Section through the bobber showing from top to bottom all the Components making up the “Cast Away Bobber”

FIG. 3 Is an Elevation of the bobber showing from top to bottom the colors of the bobber.

FIG. 4 Is a Perspective as it looks when all the components are in place.

### DESCRIPTION OF THE PREFERRED EMBODIMENT

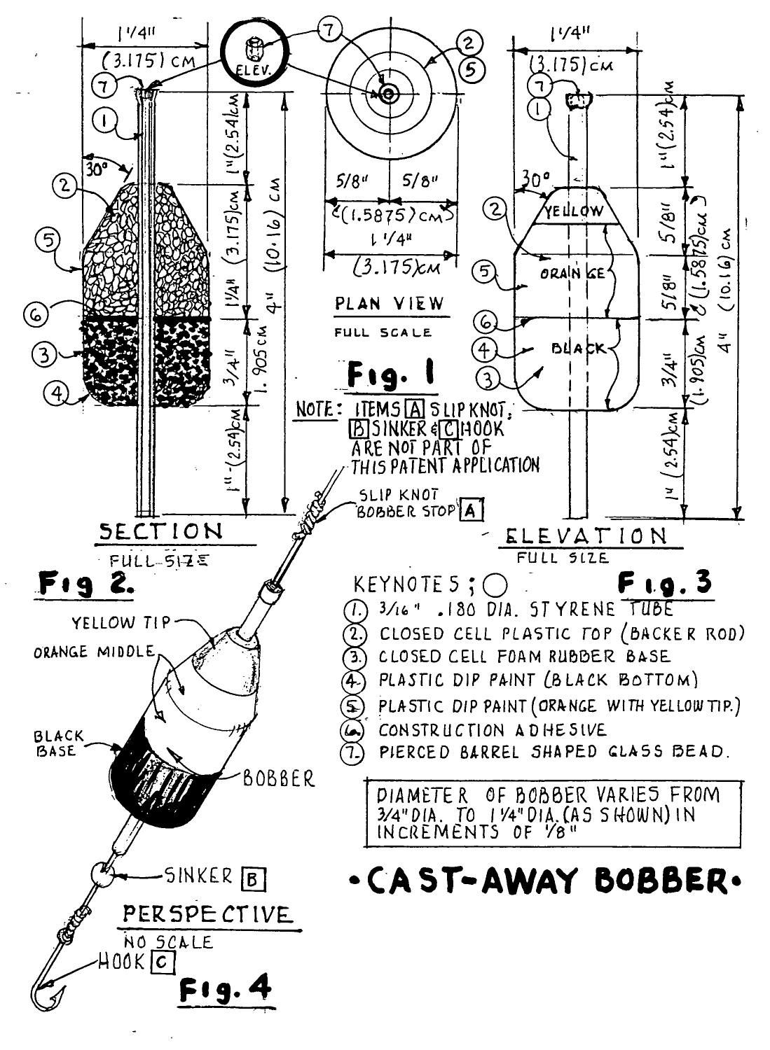

Referring to the drawing and more specifically to FIG. 1 (Plan View) looking down showing the 3/16″ diameter styrene tube #1 in the keynotes, along with the tubular pierced glass bead #7 and the closed cell plastic top with an orange body and yellow top #2 and #5 in the keynotes.

FIG. 2 Illustrates a cross section showing all the components that make up the “Cast Away Bobber”. #7 is the pierced barrel shaped glass bead, which is fiction fitted into the top of #1 the 3/16″ diameter styrene tube and acts as a guide and also a bobber stop when it comes in contact with the slip knot which is friction fitted onto the fishing line. The 3/16″ diameter styrene tube #1 which is approximately 4″ long an is spaced equal distance from each end of the bobber, #2, and #3 (the buoyant float assembly) and allows the fishing line to traverse through it. The buoyant float assembly #2, #3, #4, #5 and #6 comprising of #2 a closed cell plastic foam (the top half) also known as a backer rod in the construction industry and #3 a heavier foam rubber base. The two (2), (the closed cell plastic foam top #2 and the heavier closed cell foam rubber base #3) are then bonded together using #6 the construction adhesive. The buoyant float assembly in then shaped as shown in the section and elevation of the drawings, then drilled through the center for the ease of applying the different colors of plastic dip paint #4 and #5 and then the installation of the 3/16″ diameter styrene tube #1. While installing the 3/16″ diameter 8 styrene tube #1 a small amount of adhesive is applied at the base of the bobber so the #1 styrene tube and the float assembly are also permanently bonded together for the final step in the construction of the bobber.

FIG. 3 Is an elevation of the bobber, but more specifically where the colors occur on the bobber. The bottom portion is coated with a black #4 plastic dip paint, the upper half of the bobber receives, #5 orange plastic dip paint then the tip of the bobber gets a yellow application of the plastic dip paint for contrast and for better visibility in the water.

FIG. 4 The Perspective showing all the different components that make up the slip bobber assembly. The slip knot that stops the bobber to a predetermined set desired depth, the “Cast-Away Bobber” #1 through #7, the sinker which forces the bobber into an upright or vertical position while floating in the water and finally the hook. The items purchased separately and are not included in this Application for a Patent are the slip knot A, the sinker B, and the hook C.

1. The “Cast-Away Bobber” is comprised of a float assembly having two (2) bonded together components. A closed cell light weight plastic foam for the upper section and a heavier closed cell foam rubber base for the lower section, said float assembly having a hollow styrene tube through the center with a tubular pierced glass bead friction fitted in the top end of the hollow styrene tube. The hollow styrene tube allows the fishing line to traverse through it while casting until the bobber reaches the slip knot which stops the bobber at any set predetermined depth.

2. The “Cast-Away Bobber” as defined in claim 1 having a heavier closed cell foam rubber base allows this bobber to be cast further because of the weight of the materials used.

3. The “Cast-Away Bobber” as defined in claim 2 having a heavier closed cell foam rubber base achieves a somewhat angular position when floating in the water without additional weight being added below the bobber on the fishing line. Additional weight beings it to a vertical position when it reaches it's desired depth and also provides this bobber to be cast even further.

4. The “Cast-Away Bobber” as defined in claim 1 is made up of materials that will not break down over an extended period of time, will not fall apart when stepped on or crushed (within reason) and maybe the last bobber a person will ever need to purchase.

5. The “Cast-Away Bobber” as defined in claim 1 has an exterior coating (Plastic Dip Paint) that not only bonds the upper and lower sections together which won't scrape off, wear off, fade, crack or separate from the materials that it is bonded to over time.

6. The “Cast-Away Bobber” as defined in claim 1 with the tubular pierced glass bead friction fitted into the hollow styrene tube eliminates in most cases the application of an additional bead stopper between the friction slip knot applied to the fishing line and the bobber. The tubular pierced glass bead allows the fishing line to traverse freely and will not cause unnecessary wear on the fishing line or the bobber.
